(19) United States
(12) Patent Application Publication
(10) Pub. No.: US 2011/0292241 A1
(43) Pub. Date: Dec. 1, 2011

(54) EXTENDED FLICKER CANCELLATION FOR AUTO EXPOSURE FOR A VIDEO CAMERA

(75) Inventors: Loic Segapelli, San Francisco, CA (US); Remy Zimmermann, Belmont, CA (US); Frantz Lohier, El Cerrito, CA (US)

(73) Assignee: Logitech Europe S.A., Morges (CH)

(21) Appl. No.: 13/149,310

(22) Filed: May 31, 2011

Related U.S. Application Data
(60) Provisional application No. 61/349,880, filed on May 30, 2010.

(51) Int. Cl. H04N 9/73; H04N 5/235

(52) U.S. Cl. 348/226.1; 348/229.1; 348/E09.051; 348/E05.037

(57) ABSTRACT

A video camera includes a light collection array including a plurality of light collection cells configured to collect light from a scene and a processor coupled to the light collection array. The processor is configured determine a brightness of the scene based on the light collected by the light collection array from the scene. Based on the determined brightness, the processor is configured to determine if the brightness of the scene requires a light collection time of each cell to be less than a flicker on time of a light source lighting the scene so that the light collection array collects a sufficient amount of light so that a brightness of a video stream or a still image is substantially at a predetermined level. If the light collection time is determined to be less than the flicker on time to maintain brightness of the video stream or the still image at the predetermined level and if the brightness of the scene is less than a predetermined brightness, the processor is configured to set the light collection time at the flicker on time of the light source. If the light collection time is determined to be less than the flicker on time to maintain brightness of the video stream or the still image at the predetermined level and if the brightness of the scene is at, or greater than, the predetermined brightness, the processor is configured to set the light collection time less than the flicker on time of the light source.

The present application claims priority to provisional application Ser. No. 61/349880, entitled Extended Flicker Cancellation For Auto Exposure For A Video Camera, filed May 30, 2010, the contents of which are hereby incorporated herein by reference in their entirety.

### BACKGROUND OF THE INVENTION

The present invention generally relates to video cameras. More particularly, the present invention relates to a video camera and a video camera operation method for reducing flicker in low light and bright light.

Video cameras, such as webcams, are configured to collect light from a scene and generate a video stream for the scene from the collected light. If a light source is blinking in a scene (i.e., flickering) the generated video stream of the scene may also have flicker. Flicker includes the unwanted variation of luminous intensity within an image of a video stream from the flicker of a flickering light source. Particularly, the video stream will have flicker if the video camera collects light from the scene at a frequency that is not synchronized with the flickering light source. The flicker may scroll in a video stream (e.g., from top to bottom) depending on the scan orientation (e.g., from top to bottom) of the light collection array of the video camera. Flicker in a video stream is generally not desired as it distracts from the main subject of the video stream, such as a person viewed for an Internet telephone call.

Light sources, such as florescent lights and incandescent lights flicker at a frequency that is a whole multiple of the frequency of the power source that powers the light source. For example, florescent lights and incandescent lights that are powered by a 60 Hz alternating current power source flicker at 120 Hz. Televisions also flicker at a multiple of the frequency of an AC source. For example, televisions flicker at 120 Hz or 240 Hz for a 60 Hz AC source.

Various methods exist for reducing flicker in a video stream, which is generated by a video camera. For example, each of the cells of a light collection array may be configured to collect light for a period of time (referred to as an integration time) that is a multiple (e.g., multiple of 1, 2, 3, 4, etc.) of an amount of time that a light source is lighted as the light source flickers. However, if a scene is relatively brightly lighted, the auto expose module of a video camera may drop the integration time for a cell below the time period in which a single flicker event of a light source occurs. If the integration time of a cell is dropped below the time period of a single flicker event, then the video stream generated by the video camera will have flicker.

New video cameras and new video camera methods are needed to correct flicker in a video stream for a relatively bright light scene where the scene includes light from flickering light sources.

### BRIEF SUMMARY OF THE INVENTION

The present invention generally relates to video cameras. More particularly, the present invention relates to a video camera and a video camera operation method for reducing flicker in low light and bright light.

According to one embodiment of the present invention, the video camera may include a light collection array including a plurality of light collection cells configured to collect light from a scene and a processor coupled to the light collection array. The processor may be configured determine a brightness of the scene based on the light collected by the light collection array from the scene. The processor may be configured to, based on the determined brightness, determine if the brightness of the scene requires a light collection time of each cell to be less than a flicker on time of a light source lighting the scene so that the light collection array collects a sufficient amount of light so that a brightness of a video stream or a still image is substantially at a predetermined level. The processor may be configured to set the light collection time at the flicker on time of the light source, if the light collection time is determined to be less than the flicker on time to maintain brightness of the video stream or the still image at the predetermined level and if the brightness of the scene is less than a predetermined brightness. The processor may be configured to set the light collection time less than the flicker on time of the light source if the light collection time is determined to be less than the flicker on time to maintain brightness of the video stream or the still image at the predetermined level and if the brightness of the scene is at, or greater than, the predetermined brightness. According to one specific embodiment of the video camera, the processor may be configured to receive digital numerical output from the light collection array for each cell for single scans of the cells, and, for each scan of the cells, the processor may be configured to compute image statistics, wherein one of the image statistics is the brightness.

According to another embodiment of the present invention, a video camera method for reducing flicker in a video stream or a still image may include determining a brightness of a scene. The method may further include determining if the brightness of the scene requires a light collection time of each cell in a light collection array of the video camera to be less than a flicker on time of a light source lighting the scene so that the light collection array collects a sufficient amount of light so that a brightness of a video stream or still image generated by the video camera is substantially at a predetermined level. The method may include setting the light collection time at the flicker on time of the light source if, for example, the light collection time is determined to be less than the flicker on time to maintain the brightness of the video stream or the still image at the predetermined level and if the brightness of the scene is less than a predetermined brightness. The method may include setting the light collection time less than the flicker on time of the light source if, for example, the light collection time is determined to be less than the flicker on time to maintain the brightness of the video stream or the still image at the predetermined level and if the brightness of the scene is at, or greater than, the predetermined brightness.

According to one embodiment of the video camera method, the step of determining the brightness may include: receiving digital numerical output from the light collection array for each cell for single scans of the cells; and, for at least one scan of the cells, computing image statistics from the digital numerical output, wherein one of the image statistics is the brightness.

According to another embodiment of the video camera method, the method may include determining the flicker on time of a light source lighting a scene from, for example, a time zone of a computer to which a video camera is coupled, a detected flicker, an alternating electrical current, etc.

According to further aspects of the invention, a digital camera may include a light collection array including a plurality of light collection cells configured to collect light from a scene; and a processor coupled to the light collection array. In embodiments, the processor may be configured to change an integration time of the light collection array based on, for example, an image luminance and/or a first luminance threshold. The image luminance may be based on an image luminance from the light collection cells, image data, a measured ambient light level, etc.

In embodiments, the processor may be configured to maintain an integration time of the light collection array corresponding to a minimum flicker period beyond the first luminance threshold. In embodiments, the minimum flicker period may correspond to, for example, an integration time that is substantially equal to lx a flicker period of a light source such as florescent office lights, cathode ray tubes, etc. For instance, with a light source flicker of 120 times a second, the flicker period is 1/120[s], and the minimum flicker period as discussed herein may include an integration time of 1/120[s].

In embodiments, the processor may be configured to maintain an integration time of the light collection array corresponding to a minimum flicker period beyond the first luminance threshold up to a second luminance threshold that is greater than the first luminance threshold. In embodiments, the second luminance threshold may be 5%, 10%, 15%, 20%, 25% or 30% greater than the first luminescence threshold. For example, the first luminescence threshold may include an average image brightness of 128 (e.g., digitized pixel brightness level assuming a black pixel level is zero and a white (saturated) pixel brightness level is approximately 255), and the second luminance threshold may include an average image brightness of 160, allowing the image brightness to go approximately 25% above a normal (e.g. low-light) target value, and pushing back the flicker threshold by approximately 25% lux.

In embodiments, the processor may be configured to reduce the integration time of the light collection array when the image luminance, which may be a calculated or detected brightness, exceeds the second luminance threshold. For example, the integration time of the light collection array may be reduced at brightness levels above the second luminance threshold such that the exposures of the video or still images produced by the camera are maintained at a relatively constant level.

In embodiments, the camera may further include a flicker module configured to determine a light flicker period. The processor may be further configured to determine the minimum flicker period based on the light flicker period. The flicker module may be configured to detect a flicker period of an ambient light, and/or to distinguish between, for example, at least two of 50 Hz, 60 Hz, 120 Hz and 250 Hz flickers.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention claimed. The detailed description and the specific examples, however, indicate only preferred embodiments of the invention. Various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced. In the drawings:

FIG. 1 is a schematic depiction of an exemplary imaging system and light source according to aspects of the invention.

FIG. 2 is a graph showing a relationship between integration time and image luminance.

FIG. 3 is a depiction of synchronized and unsynchronized imaging sensors and flickering lights.

FIG. 4 is a graphical depiction of a synchronized relationship between an imaging sensor and a flickering light, with different integration timing applied for the imaging sensor.

FIG. 5 is a graphical depiction of the effects of a “stair step” integration timing on image luminance.

FIG. 6 is a schematic diagram including components of an exemplary imaging device according to aspects of the invention.

FIG. 7 is a graphical depiction of the effects of a “stair step” integration timing in which image luminance is allowed to exceed a first threshold according to aspects of the invention.

FIG. 8 is a graphical depiction of the effects of pixel design on device performance.

FIG. 9 is a flowchart depicting aspects of an exemplary method according to aspects of the invention.

### DETAILED DESCRIPTION OF THE INVENTION

It is understood that the invention is not limited to the particular methodology, protocols, etc., described herein, as these may vary as the skilled artisan will recognize. It is also to be understood that the terminology used herein is used for the purpose of describing particular embodiments only, and is not intended to limit the scope of the invention. It also is to be noted that as used herein and in the appended claims, the singular forms “a,” “an,” and “the” include the plural reference unless the context clearly dictates otherwise. Thus, for example, a reference to “a scan line” is a reference to one or more scan lines and equivalents thereof known to those skilled in the art.

Unless defined otherwise, all technical terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

The present invention generally provides techniques for use in digital cameras, and may include, for example, a video camera and a video camera operation method for reducing flicker in low light and bright light.

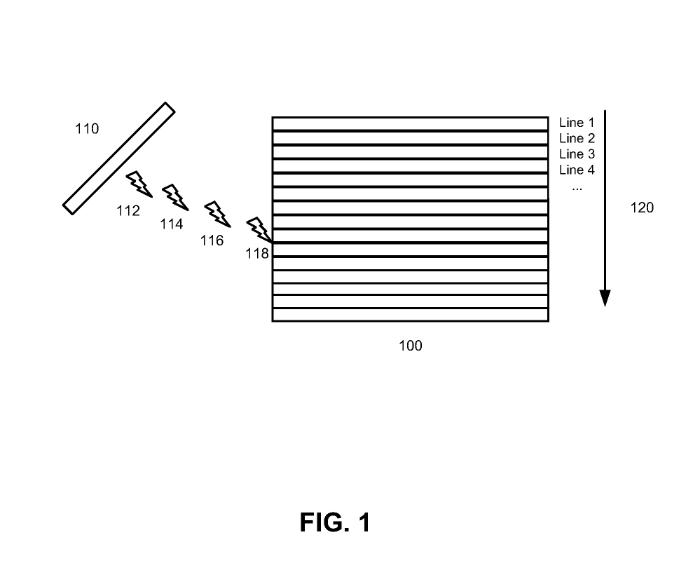

Video cameras, such as webcams, are well known peripheral devices configured for capturing light from a scene and generating a video stream from the captured light. A video camera may include a light capture array (e.g., a CMOS array, a CCD array, etc.), such as array 100 shown in FIG. 1, which include a plurality of lines or cells, which capture light from a scene. The cells typically collect light in a vertical scan direction 120 of the cells. That is, one cell is configured to collect light, thereafter a vertically adjacent cell is configured to collect light, thereafter a next vertically adjacent cell is configured to collect light, and this pattern repeats through all of the cells. The pattern repeats multiple times to generate a video stream. The cells are often referred to in the art as pixels. Cameras may also be subjected to flashing lights, such as from light source 110 which may be, for example, a fluorescent light fixture emitting flickers of light 112-118. As described further herein, the presence of flickering light may cause particular problems with digital imaging devices that rely on scanning an array of sensors to form still or video images.

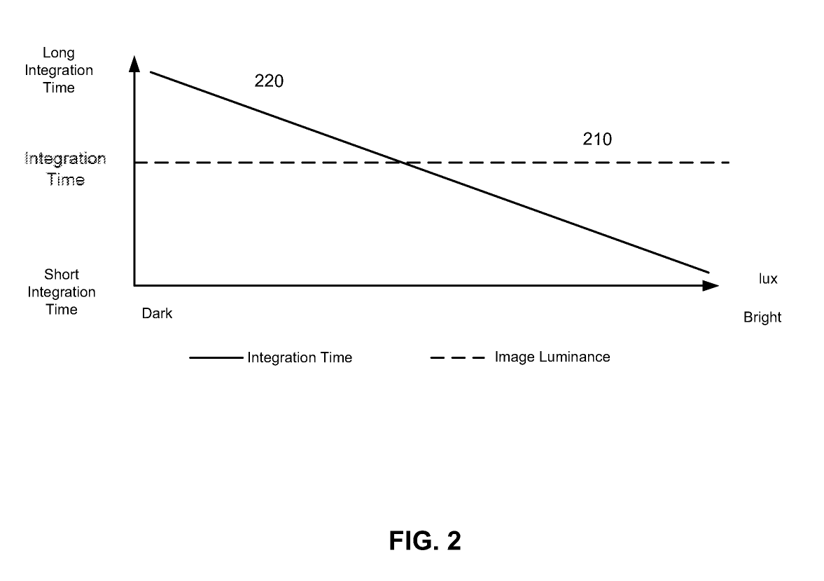

Digital cameras, such as video web cameras, may also need to adjust to a wide range of scenes, from bright outdoors to indoors office and low light environments. The illumination intensity, measured in lux ([Lm/m2]), varies from thousands lux (outdoors) to hundreds lux (office indoors) to tens of lux (home environment) or as little as a few of lux (when the only light source is the TV screen or computer monitor). Video cameras may incorporate the so-called “auto exposure” method that aims at maintaining a constant level of luminance in the image captured by the camera despite the wide range of scene brightness. One aspect of such methods including the use of a variable integration time is depicted graphically in FIG. 2, which shows brightness level increasing on the x axis and integration time increasing on the y axis. As shown in FIG. 2, in order to maintain a substantially constant image luminescence 210 along a range of brightness, the integration time 220 may be decreased as brightness increases. Image statistics (such as the average image luminance) may also be used to compute new parameters that modify the final image brightness.

In general, when a scene is very bright, pixels will saturate quickly and the image luminance target will be reached quickly, hence a short integration time is required, whereas darker scenes will require longer exposure times for the final image to achieve the same luminance. It is the role of auto exposure to adjust the integration time to keep the output image brightness as close as possible to the luminance target.

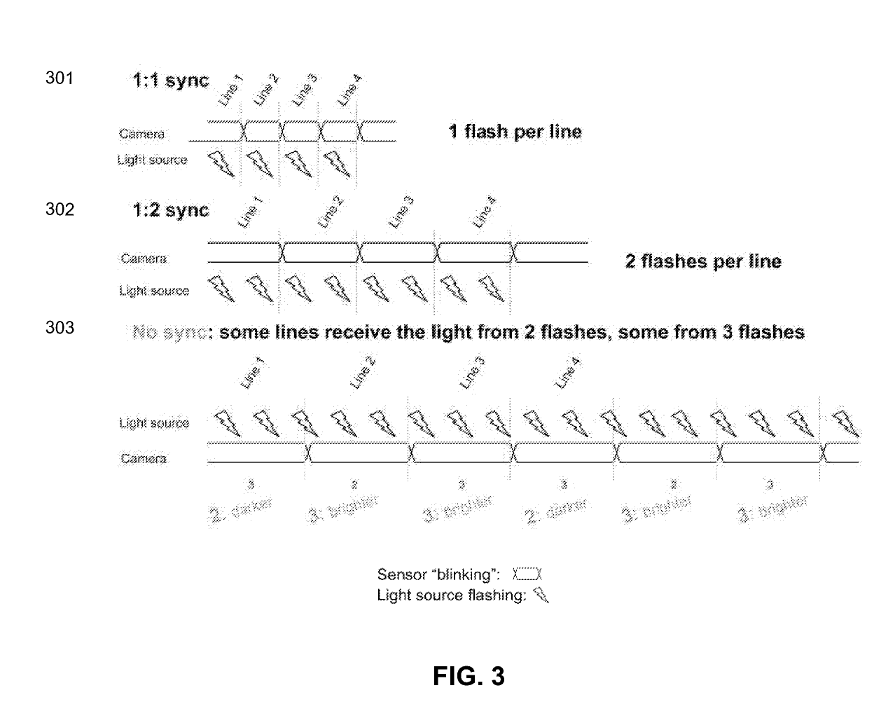

However, as mentioned above, flickering lights can cause particular problems in a video stream, or other digital imaging depending on the synchronization of the integration time and the flicker. For instance, florescent office lights and cathode ray tubes flicker with the AC power source (50 Hz or 60 Hz, causing them to “flash” 100 times or 120 times per second, respectively). LCD TV sets refresh at a rate of 120 Hz or 240 Hz. As shown in FIG. 3, sensor “blinking” for individual lines of an imaging device, e.g. lines 1-4, can be coordinated with light source flashes or flicker, as in lines 301 (1:1) and 302 (1:2), which results in a relative stable image across the lines/cells. On the other hand, if the sensor blinks (integration time) is not coordinated with the flashes, as in line 303, the brightness of individual lines can vary based on the number of flashes detected during the blink, e.g. Line 1 detects two flashes and has a darker luminance than Line 2, which detects three flashes in corresponding blink cycle.

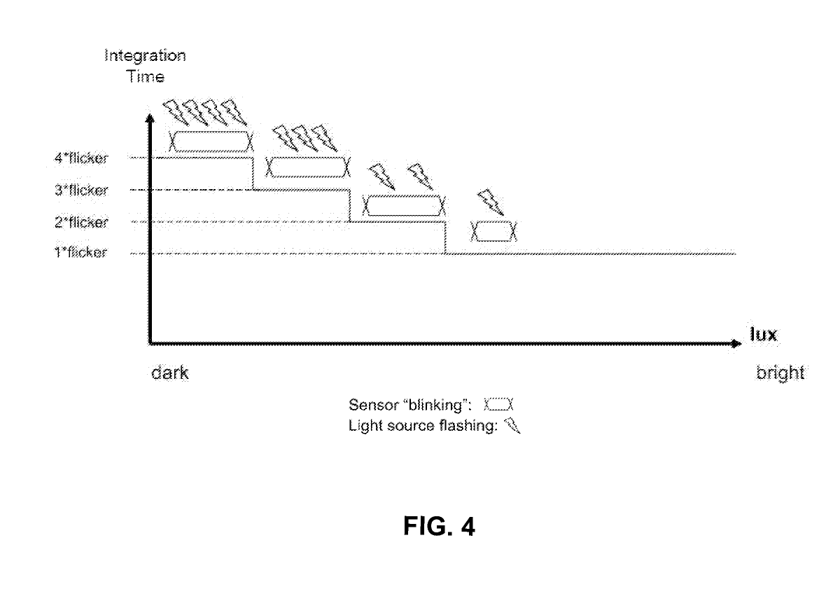

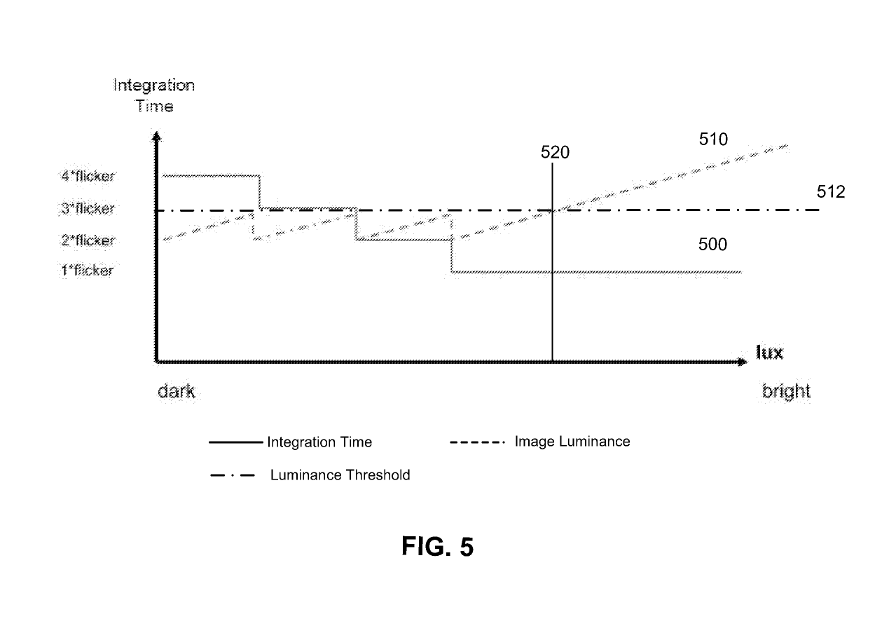

As further shown in FIG. 4, each of the cells of a light collection array may be configured to collect light for a period of time (referred to as an integration time) that is a multiple (e.g., multiple of 1, 2, 3, 4, etc.) of an amount of time that a light source is lighted, flicker on time (FT), as the light source flickers. In FIG. 4, the uppermost line represents an integration time that is 4×FT. The remaining lines are labeled as “3*flicker” for an integration time 3×FT, “2*flicker” for an integration time 2×FT, and “1*flicker” for an integration time 1×FT. The “staircase” in FIG. 4 is caused by the discrete steps between integration times as the auto exposure enforces flicker periods. Through the use of such integration times, image luminance may vary depending on the brightness of the scene, as shown in FIG. 5.

As shown in FIG. 5, as brightness increases, image luminance 510 increases when the integration time 500 is held constant. In a typical operating range, the image luminance 510 may be allowed to approach a luminance threshold 512 (e.g. a desirable image brightness) before being reduced by a factor, e.g. 3× FT to 2× FT, etc. However, if the integration time 500 is left at the 1×FT level an increase in received brightness will eventually cause the luminance 510 to exceed the luminance threshold 512, e.g. at line 520. Therefore, if a scene is relatively brightly lighted, the auto expose module of a video camera may drop the integration time for a cell below the time period in which a single flicker event of a light source occurs, i.e (integration time)<(1×FT). This may allow for the luminance 510 to maintain a relatively constant value. However, if the integration time of a cell is dropped below the time period of a single flicker event, then the video stream generated by the video camera will have flicker.

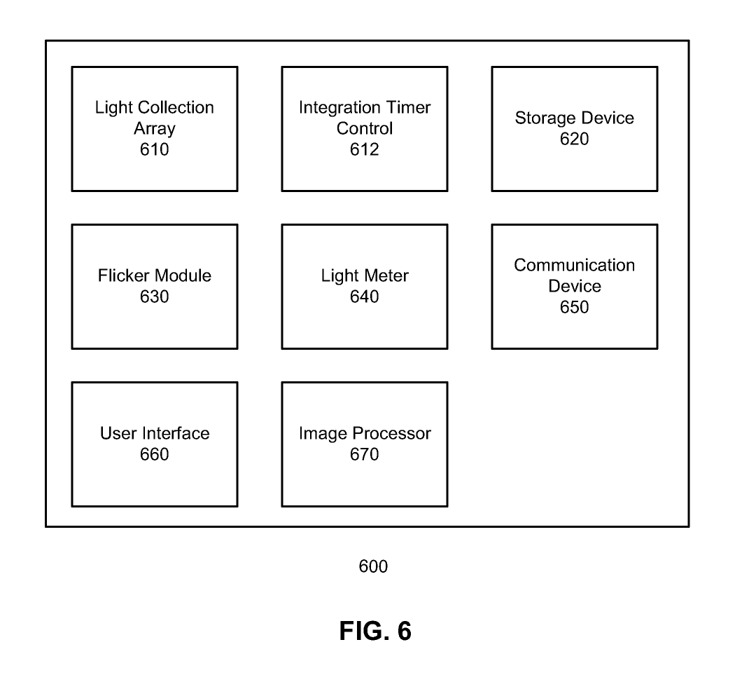

According to aspects of the present invention, digital cameras may be further configured to compensate for flickering light sources, and reduce or prevent imaging errors due to flicker throughout an expanded range. For example, components of an exemplary digital imaging device 600 according to aspects of the invention are shown schematically in FIG. 6.

As shown in FIG. 6, imaging device 600 may include one or more of a Light Collection Array 610, an Integration Timer Control 612, a Storage Device 620, a Flicker Module 630, a Light Meter 640, a Communication Device 650, a User Interface 660 and/or an Image Processor 670. One or more microprocessors may be included in the various components mentioned above, and any and/or all of the foregoing may be connected via a bus (not shown), or communicate via other means such as wireless link, IR, etc. The User Interface 660 may be used to adjust settings, activate the imaging device and other features known to those of skill in the art. The Storage Device 620 may include various electronic and other memory components described herein and known to those of skill in the art, and may be configured to store image and/or video data as well as program instructions for operating one or more processors included in Imaging System 600. The Communication Device 650 may include any wired and/or wireless communication transmitter, receiver, transceiver and the like. For example, Communication Device 650 may include a micro-USB port, and similar features, that allow the imaging device to communicate with a separate computing device.

According to an embodiment of the present invention, Imaging Device 600 may be configured to set the period of time that a cell of Light Collection Array 610 collects light to a multiple (e.g., multiple of 1, 2, 3, 4, etc.) of an amount of time that a light source is lighted as the light source flickers. The Imaging Device, if coupled to a computer, a set-top-box, etc. may be configured to interrogate the time zone programmed for the computer or the like to determine the frequency of light flicker for lights that might be exposing a scene. For example, if the Imaging Device determines that it is located in North America based on the Pacific Time Zone being set for the computer, then the Imaging Device might determine that lights lighting the scene flicker at 120 Hz based on 60 Hz AC electrical power. The Imaging Device may set the amount of time that each cell collects light to a multiple of 1/120 second, for example. It will be understood that the foregoing described time zone and time for a cell to collect light are exemplary and not limiting on the claims.

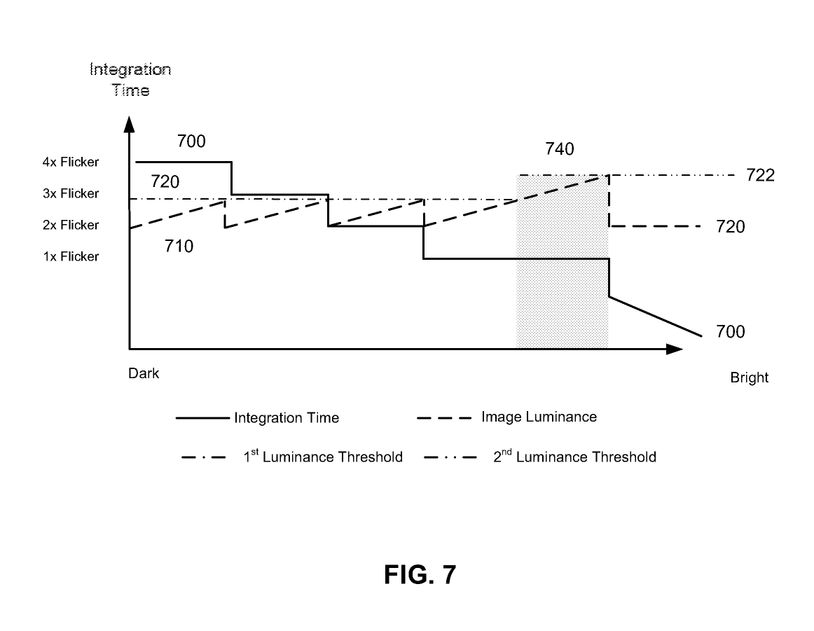

According to one embodiment, the Imaging Device 600 may include a Light Meter 640. The light meter may generally be configured to determine the amount of light that the Imaging Device 600 is collecting in a period of time and may control (in combination with Integration Timer Control 612) the amount of time that each cell in the Light Collection Array 610 collects light. The Light Meter 640 and Integration Timer Control 612 may be configured to attempt to maintain the light exposure of the cells at a “substantially constant level.” The combination of the Light Meter 640 and Integration Timer Control 612, or other processor, may sometimes be referred to as an auto exposure meter. Maintaining the light exposure of the cells to the substantially constant level generally provides for a relatively uniformly lighted video stream regardless of the brightness of a scene from with the video camera is collecting light. That is, for a low light scene and a bright light scene, brightnesses of the video streams generated from these scenes by the video camera will generally be the same. Further aspects of such configurations are shown in FIG. 7.

As shown in FIG. 7, an image luminescence 710 may be maintained close to, and under, a first threshold 720 throughout a range of “steps” in the integration timing 700. In the area 740, the image luminescence 710 may be allowed to exceed the first threshold 720, while maintaining the integration timing 700 at a constant level equal to lx the flickering light on time, which will typically cause an over-exposure of the resulting image or video. Once the image luminescence 710 reaches a second threshold 722, that is higher than the first threshold 720, the integration timing 700 may be reduced below the 1× level, to bring the image luminescence 710 back to a level at or below the first threshold 720.

Returning to FIG. 6, according to an alternative embodiment, the Imaging Device 600 may not include a light meter. The Light Collection Array 610 operating in combination with a processor and/or Integration Timer Control 612 may be configured to operate substantially similar to a light meter to determine the amount of light that the imaging device is collecting in a period of time and control in combination with Integration Timer Control 612 the amount of time that each cell in the Light Collection Array 610 collects light. Similar to the light meter, the Light Collection Array 610 in combination with a processor may be configured to attempt to maintain the light exposure of the cells at a “substantially constant level.” The combination of the Light Collection Array 610 and Integration Timer Control 612, or other processor, may sometimes be referred to as an auto exposure meter.

As is well known in the art, a light collection array is configured to detect light from a scene and generate a digital numerical output for each cell in the light collection array. The digital numerical output for each cell includes information for the total amount of light collected by the cell and is a measure of the brightness of a portion of the scene from which the cell collects light. The digital numeric output from a cell also indicates how “close” the cell is to saturation.

An average of the digital numerical output (or other statistical analysis of the digital numerical output) from all of the cells for a “single light-collection time” over which the cells are scanned once provides a measure of the average brightness of a scene. Calculated image statistics from the digital numerical output provides other information in addition to brightness as will be well understood by those of skill in the art. The average of the digital numerical output (or other statistical analysis of the digital numerical output) from all of the cells also provides information for how “close” the cells are on average from saturation. According to one embodiment, the processor may be configure to collect the digital numerical output from the light collection array for each cell for a single scan of the cells and calculate the average of this digital numerical output (or perform other statistical analysis thereon). The processor may be configured to calculate this average in a continuous and repeating manor for each scan to substantially continuously calculate the brightness of a scene.

In embodiments, a Flicker Module 630 may be configured to, for example, determine the presence and/or features of a flickering light. This may include, for example, determining that a flickering light source is illuminating the scene and/or being received by the Light Collection Array 610. Flicker may be detected by analyzing image data, light meter data etc. Features of the flickering light may also be determined by Flicker Module 630, e.g. luminance, flicker on time, etc. In embodiments, a frequency of flicker may be inferred by Flicker Module 630, for example, by determining a time zone in which the imaging device is operating, analyzing an alternating power current, etc.

According to one embodiment, the Light Meter 640 in combination with Integration Timer Control 612, or other processor, may be configured to detect the amount of light collected from a scene and adjust the multiplier for the set amount of time that a cell collects light. For a relatively low light scene, the multiplier might be four times the amount of time a light lighting a scene flickers on (e.g., 4× 1/120 second). For a relatively brighter scene, the multiplier might be set to two times the amount of time a light lighting a scene flickers on (e.g., 2× 1/120 second). According to the embodiment of the imaging device that does not include a light meter, the Light Collection Array 610 and Integration Timer Control 612, or other processor, operating substantially similarly to a light meter (as described above), may be configured to similarly adjust the multiplier for the set amount of time that a cell collects light based on the determined brightness of a scene.

According to one embodiment, the Light Meter 640 (or alternatively the Light Collection Array 610 operating in combination with a processor as a light meter) might detect an amount of light collected from a scene where the light is relatively bright, and to maintain the light exposure of the cells to the substantially constant level, the calculated multiplier might be less than one (e.g., 0.75× 1/120 second). As discussed previously, flicker may generally be avoided by setting the integration time to a non-zero integer multiplier of the light flicker time. With a multiplier less than one, flicker will be introduced into the video stream. According to one embodiment, to prevent flicker from being introduced into a video stream for the foregoing described relatively bright light scene, the processor of the camera may be configured to maintain the multiplier at one (e.g., 1× 1/120 second) and not set the multiplier less than one (e.g., 0.75× 1/120 second) even though the light exposure of the cells exceeds the substantially constant level of light exposure that the light meter is set to maintain. The processor may be configured to set the multiplier to less than one only if the light collected from the scene exceeds a predetermined “high” brightness level. The multiplier might set to lower levels as the brightness of the scene increases above the high brightness level. The high brightness level might be a function of the saturation level of the cells. According to the method, a video stream generated by a video camera may become brighter than desired for a given window of brightness of a scene, but flicker will continue to be reduced.

According to one embodiment, a video camera may be configured to reduce flicker for other light fluctuations (from a luminance and chrominance standpoint) that are not due to differences in the AC frequency of a power source. A typical situation would be a television illuminating a living room environment where the ambient light of the living room is relatively dim. Depending on the content played on the television, the fluctuation in the light intensity and the fluctuation of the color fidelity would not be directly determined by the flicker of a light bulb or an LED, but by the content displayed on the television. For this particular situation, the method for flicker reduction is extended beyond the adaptation of exposure time of the cells of the image capture array by a statistical analysis of the light variation from the television. In one such embodiment, the luma and the chroma components of the visual signal recorded by the video camera are altered in a way to provide relatively constant light intensity. On the chroma side, such a method would also boost the colors over time based on past images recorded by the video camera during the time in which the television display was strongly illuminating the scene.

According to another alternative embodiment, the video camera may be configured to generate still images. The video camera may be configured to make the calculations described above prior to taking a still image to reduce variation (essentially flicker) in brightness within a still image. For example, the video camera may set an integration time for each cell as a multiple of the time that a light lighting a scene flickers on. For a relatively bright scene were the multiplier for the integration time is less than one, the processor may set the multiplier to one up to a point where the brightness of a scene matches or exceeds the predetermined “high” brightness level. At a brightness at, or above, the predetermined high brightness level, the processor may set the multiplier for the integration time to less than one.

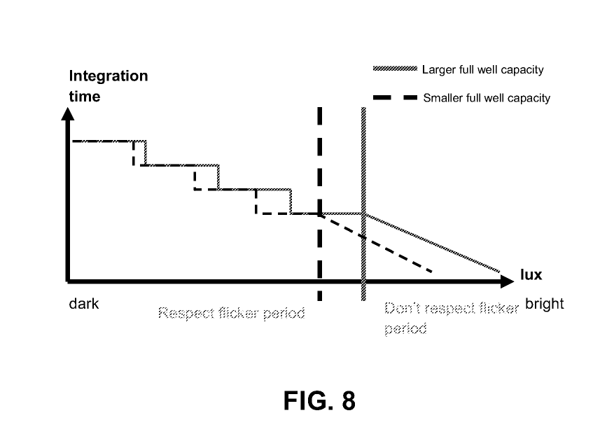

In accordance with various of the above techniques, particular advantages may be obtained, for example, in allowing pixel design bias to tend toward low light sensitivity, while achieving a broader range of operation under high light. This is particularly helpful in today's environment considering the priorities of 1) smaller imaging devices with larger resolutions, and 2) low light performance. The first trend causes the pixel size to decrease, as more pixels are needed on a smaller surface. This in turn causes the full well capacity to decrease. The second trend calls for optical systems that transfer as much light as possible to the sensor (wide aperture lenses). Pixels that are more sensitive in low light scenes will also saturate faster under high light scenes. Aspects of these relationships are shown in FIG. 8. To compensate, pixel designers can decrease the efficiency with which the pixel converts photons into electrons. Low light performance and high light performance may therefore become a trade-off. As technology enables better low light performance, it also pulls in the threshold between “indoors” and “outdoors” modes.

Computation and measurements made on a sensor with 2.2 μm pixel technology showed that the pixel would reach 25% saturation at 600 lux, while a 6.0 μm sensor tuned for low light would reach the same saturation level at 150 lux. Thus, it can be seen that pixels designed for good low-light performance are more susceptible to indoors flicker artifacts. Exemplary systems and methods may help to prevent the apparition of flicker in scenes such as a bright office environment, a bright home environment with TV set (such as a living room), recording of a TV stream by pointing the camera to the TV set, etc., by pushing back the threshold where the auto exposure will drop below the flickering period.

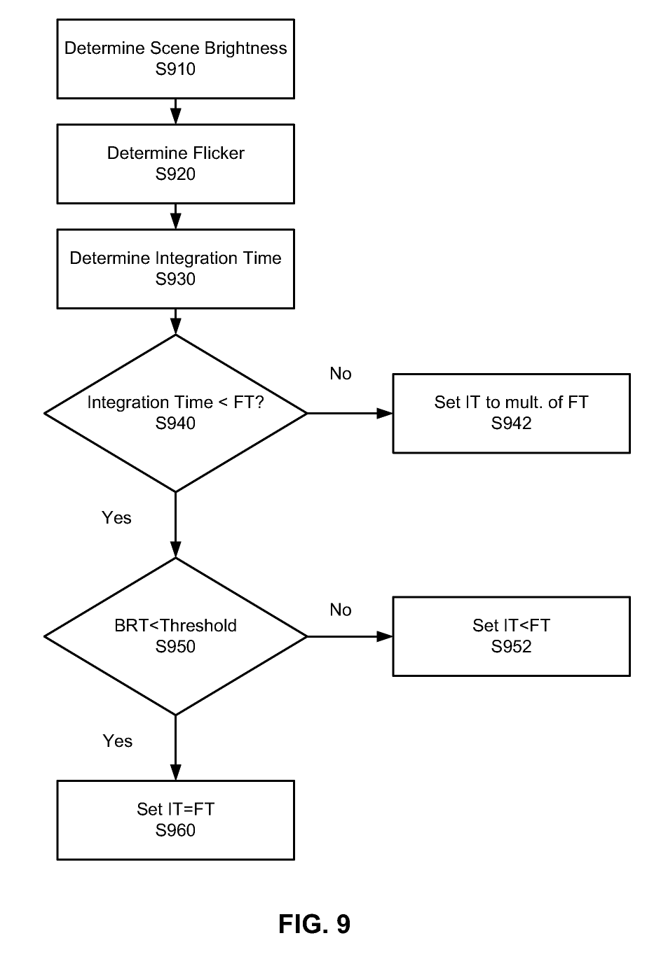

According to aspects of the invention, an exemplary imaging method may include one or more of the following steps, aspects of which are depicted in FIG. 9. The method may begin with S910 during which a scene and/or image brightness may be determined. Determining the brightness may include, for example, receiving image data, receiving digital numerical output from a light collection array of a digital imaging device and/or receiving data from a light meter. In the case of digital numerical output from a light collection array, this may be received for each cell for single scans of the cells. Determining the scene brightness may also include computing image statistics from image data, e.g. from a digital output for at least one scan of cells. Image statistics may include, for example, brightness, saturation, contrast etc. The method may continue with S920.

In S920, the presence and/or features of a flicker may be determined. This may include, for example, determining that a flickering light source is illuminating the scene and/or being received by the imaging device. Flicker may be detected by analyzing image data, light meter data etc. Features of the flickering light may also be determined, e.g. luminance, flicker on time, etc. In embodiments, a frequency of flicker may be inferred, for example, by determining a time zone in which the imaging device is operating, analyzing an alternating power current, etc. It should be noted that, if no flicker is detected, the method may repeat S910 and S920 without proceeding further to S930. That is, if there is no flicker detected, it may be unnecessary to determine an integration time for the imaging device. If a flicker is detected, the method may proceed with S930.

In S930, an integration time (IT) may be determined, for example, based on the flicker detected in S920. The IT may be set, for example, at various multiples of the flicker on time (FT), depending on the detected brightness. In general, low-light conditions may result in a higher multiple for IT than brighter conditions.

S910-S930 may be performed in an iterative manner, and adjust the IT based on various changes in brightness and/or flicker. If the scene brightness increases, the auto exposure will detect it by reading, for example, the average luminance statistics from the imaging array. This may first result in decreasing system gains including, for example, IT, digital gains and analog gains, in order to maintain the image brightness within a desired range, e.g. below a first luminance threshold, down to the point it reaches the minimum flicker period (i.e. IT=1×FT), as shown in S940.

In S940, it is determined whether the brightness of the scene requires an IT of each cell to be less than a FT of a light source lighting the scene so that the light collection array collects a sufficient amount of light so that a brightness of a video stream or still image generated by the imaging device is substantially at the first luminance threshold. If the required IT is not less than FT, then the method may proceed with S942 where IT is set to, for example, a suggested positive whole multiple of FT, e.g. 1×FT, 2×FT etc. If the required IT is less than FT, then the method may proceed with S950.

In S950, it is determined whether the brightness of the scene and/or the image luminance is less than a predetermined level, e.g. a second luminance threshold. The difference between the first luminance threshold and the second luminance threshold may represent an acceptable amount of over-exposure in which flicker may preferably be eliminated. If the brightness of the scene and/or the image luminance is less than the threshold, the method may continue with S960 where IT may be set to 1×FT. If the brightness of the scene and/or the image luminance is not less than the threshold, the method may continue with S952.

In S952, the method may correct for overexposure beyond the second threshold by setting IT to a value less than 1×FT. That is, as described herein, once the minimum flicker period is reached, the integration time may be arrested from dropping further for a range of over-exposure. The luminance statistics may continue to be read in an iterative manner and, if the second threshold if reached, the integration time may be allowed to continue to drop. Thus, sub-flicker integration time may be delayed, and complete brightness saturation avoided by setting appropriate thresholds.

For instance, 8-bit RGB images saturate at a value of 255, and it is common to target an average image brightness of 128. By setting a second threshold value of 160, the image brightness may be allowed to go 25% above target, and pushing back the flicker threshold by 25% lux.

Using this method the inventors have found a way to trade-off some over-exposure for removing flicker artifacts. This trade-off may be favorably employed as bright indoors scene are most often high key scenes for which over-exposure may be suitable. With these method, the inventors have succeeded in extending the range of operation for an imaging device indoors while still allowing the imaging device to work outdoors.

The following is an exemplary pseudo-code further representing aspects of the method described above.

```
Case 1: Indoors-to-Outdoors, image luminance is increasing
If(image is too bright) & (integration time == min flicker period)
{
  If(luminance > luminance_threshold) go into outdoors mode;
  Else leave the image over-exposed;
}
Case 2: Outdoors-to-Indoors, image luminance is decreasing
If(image is too dark) & (integration time <= integration time threshold)
{
  Force the integration time to min flicker period;
}
```

It should also be noted that, by using thresholds based on two different metrics (integration time and luminance), the inventors have established appropriate means to avoid oscillations.

In addition, embodiments of the present invention further include computer-readable storage media that include program instructions for performing various computer-implemented operations and/or calculations as described herein. The computer readable medium is any data storage device that can store data which can be thereafter be read by a electronic system. The media may also include, alone or in combination with the program instructions, data files, data structures, tables, and the like. The media and program instructions may be those specially designed and constructed for the purposes of the present subject matter, or they may be of the kind available to those having skill in the computer software arts. Examples of computer-readable storage media include magnetic media such as flash drives, hard disks, floppy disks, and magnetic tape; optical media such as CD-ROM disks; magneto-optical media; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

The computer readable medium can also be distributed over a network coupled electronic systems so that the computer readable code is stored and executed in a distributed fashion, for example, in multi-camera systems that operate over a network.

The description given above is merely illustrative and is not meant to be an exhaustive list of all possible embodiments, applications or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments.

What is claimed is:

1. A video camera comprising:
a light collection array including a plurality of light collection cells configured to collect light from a scene; and
a processor coupled to the light collection array, wherein:
the processor is configured determine a brightness of the scene based on the light collected by the light collection array from the scene,
based on the determined brightness, the processor is configured to determine if the brightness of the scene requires a light collection time of each cell to be less than a flicker on time of a light source lighting the scene so that the light collection array collects a sufficient amount of light so that a brightness of a video stream or a still image is substantially at a predetermined level,
if the light collection time is determined to be less than the flicker on time to maintain brightness of the video stream or the still image at the predetermined level and if the brightness of the scene is less than a predetermined brightness, the processor is configured to set the light collection time at the flicker on time of the light source, and
if the light collection time is determined to be less than the flicker on time to maintain brightness of the video stream or the still image at the predetermined level and if the brightness of the scene is at, or greater than, the predetermined brightness, the processor is configured to set the light collection time less than the flicker on time of the light source.

2. The video camera of claim 1, wherein the processor is configured to receive digital numerical output from the light collection array for each cell for single scans of he cells, and for each scan of the cells the processor is configure to compute image statistics, wherein one of the image statistics is the brightness.

3. The camera of claim 1, further comprising a flicker module configured to determine the flicker on time.

4. The camera of claim 3, wherein the flicker module is configured to detect the flicker on time of an ambient light.

5. The camera of claim 3, wherein the flicker module is configured to determine the flicker on time based on an analysis of an alternating electrical power current.

6. The camera of claim 3, wherein the flicker module is configured to determine the flicker on time based on a time zone read from a separate computing device.

7. The camera of claim 3, wherein the flicker module is configured to distinguish between at least two of 50 Hz, 60 Hz, 120 Hz and 250 Hz flickers.

8. A video camera method comprising:
determining a brightness of a scene;
determining if the brightness of the scene requires a light collection time of each cell in a light collection array of the video camera to be less than a flicker on time of a light source lighting the scene so that the light collection array collects a sufficient amount of light so that a brightness of a video stream or still image generated by the video camera is substantially at a predetermined level;
if the light collection time is determined to be less than the flicker on time to maintain the brightness of the video stream or the still image at the predetermined level and if the brightness of the scene is less than a predetermined brightness, setting the light collection time at the flicker on time of the light source; and
if the light collection time is determined to be less than the flicker on time to maintain the brightness of the video stream or the still image at the predetermined level and if the brightness of the scene is at, or greater than, the predetermined brightness, setting the light collection time less than the flicker on time of the light source.

9. The video camera method of claim 8, further comprising determining the flicker on time of a light source lighting a scene from a time zone of a computer to which a video camera is coupled.

10. The video camera method of claim 8, wherein the step of determining the brightness includes:
receiving digital numerical output from the light collection array for each cell for single scans of he cells; and
for at least one scan of the cells computing image statistics from the digital numerical output, wherein one of the image statistics is the brightness.

11. The video camera method of claim 8, further comprising determining the flicker on time of a light source lighting the scene based on a statistical analysis of light variation from a television.

12. A video camera comprising:
a light collection array including a plurality of light collection cells configured to collect light from a scene; and
a processor coupled to the light collection array, wherein:
the processor is configured to change an integration time of the light collection array based on an image luminance and a first luminance threshold; and
the processor is configured to maintain an integration time of the light collection array corresponding to a minimum flicker period beyond the first luminance threshold.

13. The camera of claim 12, wherein the image luminance is based on an image luminance from the light collection cells.

14. The camera of claim 12, wherein the image luminance is based on a measured ambient light level.

15. The camera of claim 12, wherein the processor is configured to maintain an integration time of the light collection array corresponding to a minimum flicker period beyond the first luminance threshold up to a second luminance threshold that is greater than the first luminance threshold.

16. The camera of claim 15, wherein the processor is configured to reduce the integration time of the light collection array when the image luminance exceeds the second luminance threshold.

17. The camera of claim 12, further comprising a flicker module configured to determine a light flicker period,
wherein, the processor is further configured to determine the minimum flicker period based on the light flicker period.

18. The camera of claim 17, wherein the flicker module is configured to detect a flicker period of an ambient light.

19. The camera of claim 17, wherein the flicker module is configured to distinguish between at least two of 50 Hz, 60 Hz, 120 Hz and 250 Hz flickers.

20. The camera of claim 12, wherein the processor is further configured to determine a flicker on time of a light source lighting a scene based on a statistical analysis of an irregular light source.
